(19) United States
(12) Patent Application Publication
(10) Pub. No.: US 2007/0183266 A1
(43) Pub. Date: Aug. 9, 2007

(54) Universal time display

(76) Inventor: Young Jin Han, Burnaby (CA)

Correspondence Address: PARK LAW FIRM, 3255 WILSHIRE BLVD, SUITE 1110, LOS ANGELES, CA, 90010, US

(21) Appl. No.: 11/348,908

(22) Filed: Feb. 7, 2006

(51) Int. Cl. G04B 19/22

(52) U.S. Cl. 368/21

(57) ABSTRACT

A universal time display includes location indicators, each of which displays the local time of a predetermined location in the world. Each of the location indicators automatically displays the local time of the predetermined location including daylight saving time setting of the predetermined location. The daylight saving time is set in the display including daylight saving time information that is updated via a public communication network, such as the Internet, and the wireless phone network, etc. The universal time display is adapted to be included in a digital equipment including the computer, cell phone and other digital devices. The location indicator that displays the local time of a user is positioned at the uppermost position of the display. When one of the location indicators is selected, the selected location indicator changes brightness or size so that the selected location indicator is distinguished from the background.

### BACKGROUND OF THE INVENTION

The present invention relates to a universal time display. More particularly, this invention relates to a universal time display with which daylight saving time is always correctly displayed without user intervention or awareness.

Display of universal time is required and very useful for travelers, people who are involved in international business, and for the general public in order to check working time or convenient time for international calling for those who work or reside on the other locations of the globe.

The universal time is based on the concept of time zones. All clocks within each of the time zones would be set to the same time as others, but so as to differ by one hour from those in the neighboring zones.

Circular display is especially convenient for displaying universal time, since a single circle may represent all of the 24 time zones by equally spaced radial lines that correspond to major cities. A typical universal time display by prior art includes a circular plate that is rotatable and a fixed hour indicating ring that surrounds the circular plate. By rotating the circular plate until an indicator, which corresponds to a user's current time zone or location, points to the local time of the user's time zone, the user can check and know the local time of all other time zones.

The adoption of daylight saving time has complicated such simple scheme of universal time display. In countries or regions that adopt daylight saving time, the official time is adjusted forward, usually one hour from its official standard time, remaining that way for the duration of the spring and summer months. Countries adopting daylight saving time include Canada, United States, European countries, Australia, New Zealand, and Mexico, etc. The starting date, duration or even the adjusting amount is different from country to country and depending on the internal administrative regions in the countries. The adoption for daylight saving time or the implementation details such as the starting date and duration may vary for a particular year.

JP 55004555 shows a prior art example of displaying daylight saving time. A general time mark and a summer time mark are used as a set for displaying daylight saving time for a particular location. The disadvantage of JP55004555 is that the summer time marker only indicates that daylight saving time may be adopted at a particular location, and does not indicate that daylight saving time is actually adopted at the particular location at a given date of the year. Also, the display of the general time mark and the summer time mark at the same time is confusing, and degrades the aesthetic appearance of the clock.

Nowadays, time display is incorporated in almost all of the digital equipments other than a watch or a clock, including the computer, wireless phone, digital camera, camcorder, MP3 player, GPS and PDA, etc.

A universal time display that can display daylight saving time automatically for worldwide locations and can be incorporated into display of digital equipments has long been in need.

### SUMMARY OF THE INVENTION

The present invention contrives to solve the disadvantages of the prior art.

An objective of the invention is to provide a universal time display that automatically displays daylight saving time for a particular location.

Another objective of the invention is to provide a universal time display that can be incorporated as part of display of digital equipments.

Still another objective of the invention is to provide a universal time display that provides an easy and aesthetically pleasing check of universal time.

In order to achieve the above objectives, the present invention provides a universal time display that includes a plurality of location indicators, each of which displays the local time of a predetermined location in the world. Each of the location indicators automatically displays the local time of the predetermined location including daylight saving time setting of the predetermined location.

The automatic display of the daylight saving time is performed without user input.

The daylight saving time information is stored in the universal time display. The daylight saving time information is communicated to the universally display only when there is a change for the daylight saving time information. The daylight saving time is set in the display including daylight saving time information that is provided via a public communication network.

The daylight saving time information includes the starting date of the daylight saving time and the end date of the daylight saving time.

The public communication network includes the Internet, and the wireless phone network, etc.

The universal time display may include a digital screen, and the location indicators indicate the time and location on the digital screen.

Preferably, the universal time display is adapted to be included in a digital equipment. In this case, the universal time display is provided as a software module that is adapted to be embedded in the digital equipment. The digital equipment includes a computer, a cell phone, a video game machine, a digital camera, a camcorder, an MP3 player, a GPS and a PDA, etc.

The universal time display further includes a circular back display. The location indicators are provided as radial lines on the circular back display.

When one of the location indicators is selected for example, for displaying the local time of a user of the universal time display, the selected location indicator moves to the uppermost position of the circular back display and all of the other location indicator move accordingly. The hour ring displays local times of predetermined locations that correspond to the location indicators. When one of the location indicators is selected, the selected location indicator changes brightness or size so that the selected location indicator is distinguished from the circular back display.

The location indicators are distinguished among one another by being displayed with a city name associated with a particular location.

The universal time display further includes an auxiliary ring that includes a plurality of auxiliary indicators that are radially aligned with the location indicators.

The hour ring rotates counterclockwise. One rotation of the hour ring takes 24 hours per day.

The circular back display may further include a time indicator that displays the minute of the present time. When one of the location indicators is selected, the time indicator also displays the hour of the local time of the selected location indicator.

The circular back display further includes an hour ring that is provided on the periphery of the circular back display. The hour ring shows the time difference between time zones by hour and fragments of hour.

The advantages of the present invention are: (1) the universal time display displays local time precisely without user interpretation when a particular time zone adopts daylight saving time; (2) the universal time display effectively utilizes digital graphic display; and (3) the universal time display may be provided as an integrated function of popular digital equipments.

Although the present invention is briefly summarized, the fuller understanding of the invention can be obtained by the following drawings, detailed description and appended claims.

### BRIEF DESCRIPTION OF THE DRAWINGS

These and other features, aspects and advantages of the present invention will become better understood with reference to the accompanying drawings, wherein:

FIG. 1 is an elevation view showing a universal time display according to the present invention; and

FIG. 2 is a block diagram showing how the daylight saving time information is provided and the universal time display is controlled according to the provided information.

### DETAILED DESCRIPTION OF THE INVENTION

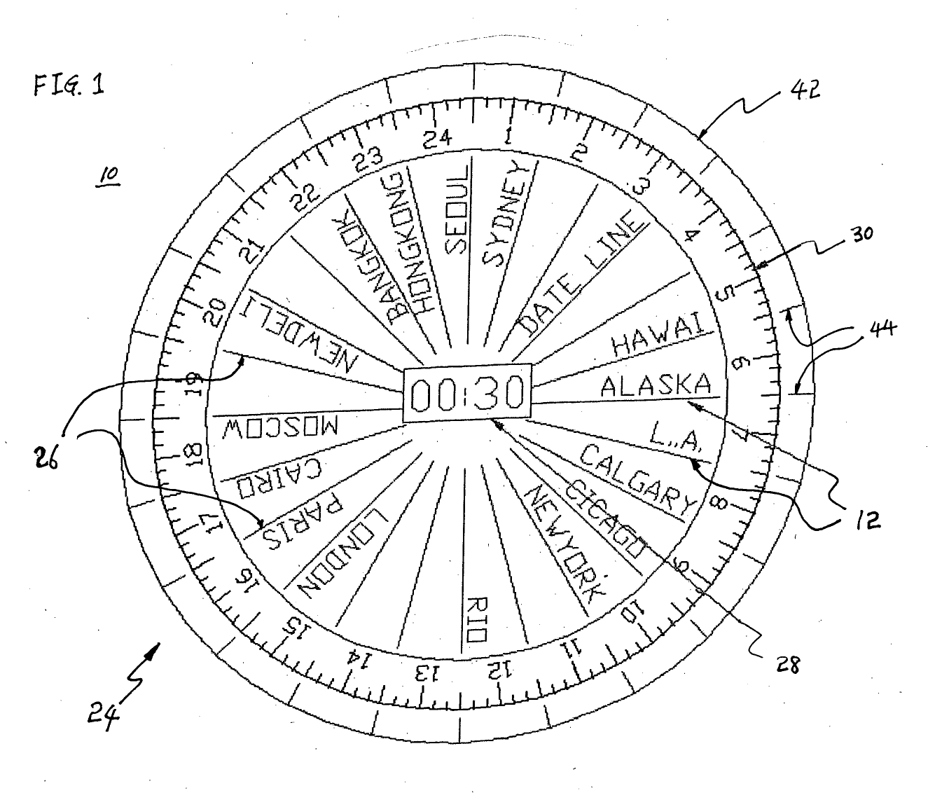

FIG. 1 shows a universal time display 10 of the present invention. The universal time display 10 includes a plurality of location indicators 12, each of which displays the local time of a predetermined location in the world. The location indicators 12 represent time zones by displaying the name of a major city that are located in a particular time zone. Other methods of representing time zones like displaying geographical map or name of country and continent may equally be used.

Each of the location indicators 12 automatically displays the local time of the predetermined location according to daylight saving time setting of the predetermined location.

The automatic display of the daylight saving time is performed without user input. Since the daylight saving time is always automatically displayed, a user does not need to be aware of adoption of daylight saving time for a particular location of the world.

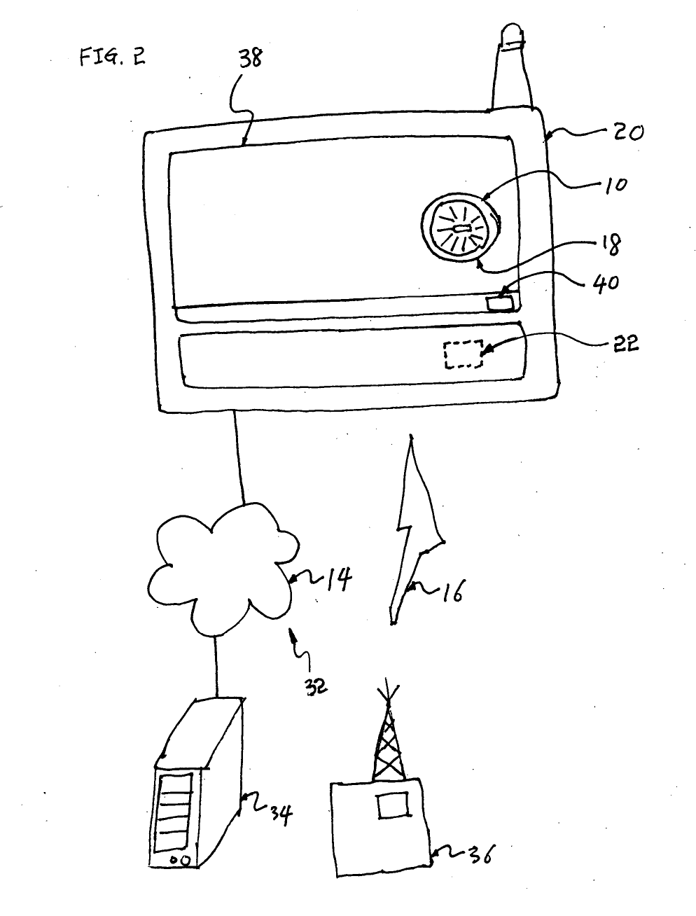

FIG. 2 shows how the universal time is displayed with automatic daylight saving time adjustment.

The universal time display includes a digital screen 18, and the location indicators 12 indicate the time and location on the digital screen 18.

The universal time display 10 is adapted to be included in a digital equipment 20. The universal time display 10 is provided as a software module 22 that is adapted to be embedded in the digital equipment 20. The digital equipment 20 may be a computer, a cell phone, a video game machine, a digital camera, a camcorder, an MP3 player, a GPS and a PDA, etc. The universal time display 10 may be displayed as a fixed part of a display screen 38 of the digital equipment 20, or may be invoked by clicking an icon 40 that may be a standard tray icon for the digital equipment 20.

The daylight saving time information is stored in the software module 22 of the universal time display 10. The daylight saving time information is communicated to the universally display 10 only when there is a change for the daylight saving time information. That is, the daylight saving time information is updated via a public communication network only when there is a change in the information. The daylight saving time is set in the software module 22 for the universal time display 10 according to daylight saving time information that is provided via a public communication network 32. The public communication network 32 includes the Internet 14, and the wireless phone network 16, etc. An internet server 34 or a communication station 36 collects the daylight saving time information for the time zones and provides the daylight saving time information to the digital equipment 20 via the public communication network 32. The daylight saving time information includes the starting date of the daylight saving time and the end date of the daylight saving time. This information is synchronized with the software module 22. The software module 22 is adapted to use clock and graphic display functions of the digital equipment 20, and to store and synchronize the daylight saving time information.

When the digital equipment 20 is turned on, and thus the display screen 38 is initialized, or the icon 40 is clicked, the software module 22 prepares information to graphically display the universal time display 10. The software module 22 uses the internal clock of the digital equipment 20 and the daylight saving time information that are stored in the software module 22.

Initially, the universal time display 10 displays the location indicator 12 that corresponds to the local time of the location in which the user resides, or other time zone that the user designates. When the user selects other time zone, the universal time display 10 displays the location indicator 12 that corresponds to the selected time zone.

Referring back to FIG. 1, the universal time display 10 further includes a circular back display 24. The location indicators 12 are provided as radial lines 26 on the circular back display 24. The location indicators 12 are distinguished among one another by being displayed with a city name associated with a particular location.

When one of the location indicators 12 is selected, the selected location indicator 12 changes brightness or size so that the selected location indicator 12 is distinguished from the circular back display 24 and from other location indicators 12. For example, only the selected location indicator 12 may be visible from the dark background, or the selected location indicator 12 may be magnified or blink.

When one of the location indicators 12 is selected for example, for displaying the local time of a user of the universal time display 10, the selected location indicator 12 moves to the uppermost position of the circular back display 24, that is the 12 o'clock position of an ordinary clock, and all of the other location indicator 12, the associated city names in effect, move accordingly. The hour ring 30 displays local times of predetermined locations that correspond to the location indicators 12. In this way, the universal time display 10 displays all of the universal times including the user's local time simultaneously. In FIG. 1, the user is located in Seoul, Korea, and the location indicator 12 is positioned at the uppermost position, and the city name “Seoul” is highlighted. The local time is 0:30 AM, and the local time in Los Angeles 7:20 AM, and the local time in London is 3:30 PM. The local time in Sydney is 1:30 AM, and daylight saving time is adopted in Sydney in the example shown in FIG. 1.

If adoption of daylight saving time begins or ends at a given moment, the city name associated with the change automatically changes its position in the circular back display 24.

The universal time display further includes an auxiliary ring 42 that includes a plurality of auxiliary indicators 44 that are radially aligned with the location indicators 12.

The hour ring 30 rotates counterclockwise. One rotation of the hour ring 30 takes 24 hours per day.

The circular back display 24 further includes a time indicator 28 that displays the minute of the present time. When one of the location indicators 12 is selected, the time indicator 28 also displays the hour of the local time of the selected location indicator 12.

The circular back display 24 further includes an hour ring 30 that is provided on the periphery of the circular back display 24. The hour ring 30 shows the time difference between time zones by hour and fragments of hour.

While the invention has been shown and described with reference to different embodiments thereof, it will be appreciated by those skilled in the art that variations in form, detail, compositions and operation may be made without departing from the spirit and scope of the invention as defined by the accompanying claims.

What is claimed is:

1. A universal time display comprising a plurality of location indicators, each of which displays the local time of a predetermined location in the world, wherein each of the location indicators automatically displays the local time of the predetermined location according to daylight saving time setting of the predetermined location.

2. The universal time display of claim 1, wherein the automatic display of the daylight saving time is performed without user input.

3. The universal time display of claim 2, wherein the daylight saving time is set in the display according to daylight saving time information that is provided via a public communication network.

4. The universal time display of claim 2, wherein the daylight saving time information includes the starting date of the daylight saving time and the end date of the daylight saving time.

5. The universal time display of claim 3, wherein the public communication network is the Internet.

6. The universal time display of claim 3, wherein the public communication network is the wireless phone network.

7. The universal time display of claim 1, further comprising a digital screen, and the indicators indicate the time and location on the digital screen.

8. The universal time display of claim 7, wherein the universal time display is adapted to be included in a digital equipment.

9. The universal time display of claim 8, wherein the universal time display comprises a software module that is adapted to be embedded in the digital equipment.

10. The universal time display of claim 9, wherein the digital equipment includes a computer, a cell phone, a video game machine, a digital camera, a camcorder, an MP3 player, a GPS or a PDA.

11. The universal time display of claim 7, further comprising a circular back display, wherein the location indicators are provided as radial lines on the circular back display.

12. The universal time display of claim 11, wherein when one of the location indicators is selected, the selected location indicator changes brightness whereby the selected location indicator is distinguished from the circular back display.

13. The universal time display of claim 11, wherein when one of the location indicators is selected, the selected location indicator changes size whereby the selected location indicator is distinguished from the circular back display.

14. The universal time display of claim 11, wherein when one of the location indicators is selected, the selected location indicator moves to the uppermost position of the circular back display and all of the other location indicator move accordingly.

15. The universal time display of claim 11, wherein the circular back display further comprises a time indicator that displays the minute of the present time.

16. The universal time display of claim 15, wherein when one of the location indicators is selected, the time indicator displays the hour of the local time of the selected location indicator.

17. The universal time display of claim 15, wherein the circular back display further comprises an hour ring that is provided on the periphery of the circular back display, wherein the hour ring shows the time difference between time zones by hour and fragments of hour.

18. The universal time display claim 17, wherein the local time of a user is displayed at the uppermost position of the circular back display, wherein the hour ring displays local times of predetermined locations that correspond to the location indicators.

19. The universal time display claim 18, wherein the location indicators are distinguished among one another by being displayed with a city name associated with a particular location.

20. The universal time display claim 19, further comprising an auxiliary ring, wherein the auxiliary ring comprises a plurality of auxiliary indicators that are radially aligned with the location indicators.

21. The universal time display claim 18, wherein the hour ring rotates counterclockwise, wherein one rotation of the hour ring takes 24 hours per day.

22. The universal time display claim 21 wherein the automatic display of the daylight saving time is performed without user input, wherein the daylight saving time is set in the display according to daylight saving time information that is provided via a public communication network.

23. The universal time display claim 22, wherein the daylight saving time information is stored in the universal time display, wherein the daylight saving time information is communicated to the universally display only when there is a change for the daylight saving time information.
